(19) United States
(12) Patent Application Publication
(10) Pub. No.: US 2023/0046190 A1
(43) Pub. Date: Feb. 16, 2023

(54) DIAGNOSIS SYSTEM, DIAGNOSIS METHOD, AND RECORDING MEDIUM

(71) Applicant: Mitsubishi Electric Corporation, Tokyo (JP)

(72) Inventors: Naoki SUGAWARA, Tokyo (JP); Ryo KASHIWAGI, Tokyo (JP); Motoyuki OZAKI, Tokyo (JP)

(73) Assignee: Mitsubishi Electric Corporation, Tokyo (JP)

(21) Appl. No.: 17/792,719

(22) PCT Filed: Mar. 30, 2020
(86) PCT No.: PCT/JP2020/014646

§ 371 Date: Jul. 14, 2022

(51) Int. Cl. G05B 19/418

(52) U.S. Cl. CPC G05B 19/41875; G05B 19/4183

(57) ABSTRACT

A diagnosis system diagnoses presence or absence of an abnormality from data pieces collected in a factory. The diagnosis system includes (i) a diagnoser that diagnoses presence or absence of an abnormality by classifying, in accordance with a diagnosis model defining a plurality of groups, the collected data pieces into at least one of the plurality of groups, (ii) an extractor that extracts, from the collected data pieces, a candidate for a data piece to belong to a new group different from the plurality of groups, (iii) a reception device that provides candidate information relating to the candidate extracted by the extractor, (iv) and a learner that learns a new model including the new group. The diagnoser diagnoses presence or absence of an abnormality with the new model after the new model is learned.

### TECHNICAL FIELD

The present disclosure relates to a diagnosis system, a diagnosis method, and a program.

### BACKGROUND ART

At many sites using factory automation (FA), the states of equipment and devices in a factory are diagnosed using sensor data from sensors attached to the equipment and the devices. Such diagnosis is performed to detect abnormalities such as the states in which a diagnosis target device operates abnormally and in which a diagnosis target device has any other abnormality signs, and one or more specific types of abnormalities among multiple types of abnormalities.

Such diagnosis using sensor data is usually performed manually by skilled workers. However, checking such data is time-consuming also for skilled workers. Thus, the equipment and devices may determine their states in real time, and inform any detected abnormality to an operator. Techniques have been developed for acquiring data from a sensor to determine the machine operating state and detecting an abnormality (for example, see Patent Literature 1).

Patent Literature 1 describes a technique for determining the operating state of a machine tool by clustering the feature quantity calculated from data and assigning, to each cluster, a label indicating the operating state. This technique can detect abnormalities through calculation of the abnormality level from the feature quantity based on the clustering result or the assigned label. The technique described in Patent Literature 1 can inform the abnormality in a machine tool to a user.

### CITATION LIST

### Patent Literature

Patent Literature 1: International Publication No. WO 2017/090098

### SUMMARY OF INVENTION

### Technical Problem

Patent Literature 1 describes alerting a user upon detecting an unknown cluster that cannot be labeled using available knowledge and leaving the labeling to an operator's discretion, and also describes an example procedure performed by a user for correcting a determination result of the operating state. However, Patent Literature 1 describes a user changing labels to be assigned to clustering results, without describing updating of the clustering procedure. Once wrong clustering different from that intended by a user is performed, such clustering may be retained. Thus, the accuracy of diagnosing presence or absence of an abnormality is to be improved.

An objective of the present disclosure is to improve the accuracy of diagnosing presence or absence of an abnormality.

### Solution to Problem

To achieve the above objective, a diagnosis system according to an aspect of the present disclosure is a diagnosis system for diagnosing presence or absence of an abnormality from data pieces collected in a factory. The diagnosis system includes (i) diagnosis means for diagnosing presence or absence of an abnormality by classifying, in accordance with a model defining a plurality of groups, the collected data pieces into at least one of the plurality of groups, (ii) extraction means for extracting, from the collected data pieces, a candidate for a data piece to belong to a new group different from the plurality of groups, (iii) reception means for providing candidate information relating to the candidate extracted by the extraction means, and receiving addition information indicating whether the new group is to be added to the plurality of groups, and (iv) learning means for learning a new model including the new group when the addition information received by the reception means indicates that the new group is to be added to the plurality of groups. The diagnosis means diagnoses presence or absence of an abnormality with the new model after the learning means learns the new model.

### Advantageous Effects of Invention

In the present disclosure, the extraction means extracts a candidate for a data piece to belong to a new group from collected data pieces, and the learning means learns a new model when the addition information received by the reception means indicates that the new group is to be added to the plurality of groups. Thus, the diagnosis system can learn a new model when addition of the new group is appropriate, and diagnose presence or absence of an abnormality with the new model. Thus, the diagnosis system can improve the accuracy of diagnosing presence or absence of an abnormality.

### BRIEF DESCRIPTION OF DRAWINGS

FIG. 1 is a block diagram of a diagnosis system according to Embodiment 1;

FIG. 2 is a diagram of a diagnosis device in Embodiment 1 showing the hardware configuration;

FIG. 3 is a functional block diagram of the diagnosis device in Embodiment 1;

FIG. 4 is a first table showing example learning data in Embodiment 1;

FIG. 5 is a first graph showing an example data distribution in Embodiment 1;

FIG. 6 is a first graph showing learning of a diagnosis model in Embodiment 1;

FIG. 7 is a first table showing an example diagnosis model in Embodiment 1;

FIG. 8 is a second graph showing learning of a diagnosis model in Embodiment 1;

FIG. 9 is a second table showing an example diagnosis model in Embodiment 1;

FIG. 10 is a second table showing example learning data in Embodiment 1;

FIG. 11 is a second graph showing an example data distribution in Embodiment 1;

FIG. 12 is a table showing an example new-group candidate data in Embodiment 1;

FIG. 13 is a graph showing an example new-group candidate data distribution in Embodiment 1;

FIG. 14 is a table showing example candidate information in Embodiment 1;

FIG. 15 is a first diagram showing an example screen in Embodiment 1;

FIG. 16 is a second diagram showing an example screen in Embodiment 1;

FIG. 17 is a third table showing example learning data in Embodiment 1;

FIG. 18 is a third graph showing an example data distribution in Embodiment 1;

FIG. 19 is a third graph showing learning of a diagnosis model in Embodiment 1;

FIG. 20 is a third table showing an example diagnosis model in Embodiment 1;

FIG. 21 is a fourth graph showing learning of a diagnosis model in Embodiment 1;

FIG. 22 is a fourth table showing an example diagnosis model in Embodiment 1;

FIG. 23 is a flowchart showing a process of updating a diagnosis model in Embodiment 1;

FIG. 24 is a flowchart showing a diagnosis process in Embodiment 1;

FIG. 25 is a flowchart showing a new-group generation process in Embodiment 1;

FIG. 26 is a flowchart showing a model updating process in Embodiment 1;

FIG. 27 is a block diagram of a diagnosis system according to Embodiment 2;

FIG. 28 is a first diagram showing an example screen in a modification;

FIG. 29 is a second diagram showing an example screen in a modification;

FIG. 30 is a third diagram showing an example screen in a modification;

FIG. 31 is a diagram showing an example decision tree in a modification; and

FIG. 32 is a graph describing supervised learning in a modification.

### DESCRIPTION OF EMBODIMENTS

A diagnosis system 100 according to one or more embodiments of the present disclosure is described in detail with reference to drawings.

### Embodiment 1

The diagnosis system 100 according to the present embodiment diagnoses presence or absence of an abnormality from data pieces collected in a factory, and is built as part of a processing system such as a manufacturing system, a machining system, or an inspection system. A factory may include a plant. Abnormalities result from deviation of the operating state of equipment, devices, apparatuses, and a combination of these installed at a factory, from a normal state intended by a factory manager. Examples of abnormalities may include detection of defectives in a manufacturing line, breakage of mechanical components, errors in executing software, and communication errors.

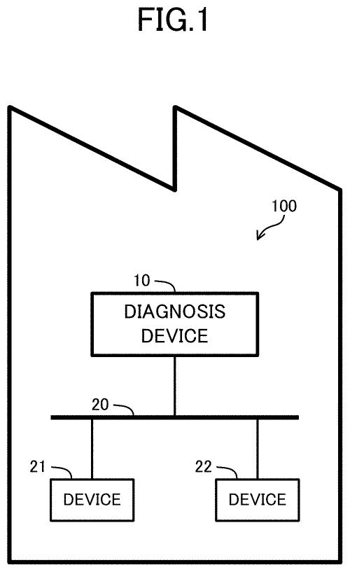

As shown in FIG. 1, the diagnosis system 100 includes a diagnosis device 10 that diagnoses presence or absence of an abnormality, and devices 21 and 22 for which the states are diagnosed by the diagnosis device 10. The diagnosis device 10 and the devices 21 and 22 are connected through an industrial network 20.

The devices 21 and 22 are sensor devices, actuators, or robots installed on a factory manufacturing line, and periodically transmit, to the diagnosis device 10, sensing results from, for example, a pressure sensor, an ultrasonic sensor, a magnetic sensor, or an infrared sensor. Data indicating the sensing results transmitted from the devices 21 and 22 are monitored by the diagnosis device 10 to be used for diagnosing presence or absence of an abnormality. Instead of the two devices, the diagnosis system 100 may include one device, or more than two devices similar to the devices 21 and 22.

The diagnosis device 10 is, for example, an industrial personal computer (IPC) or a programmable logic controller (PLC). The diagnosis device 10 may be a control device that operates a manufacturing line by controlling multiple devices including the devices 21 and 22.

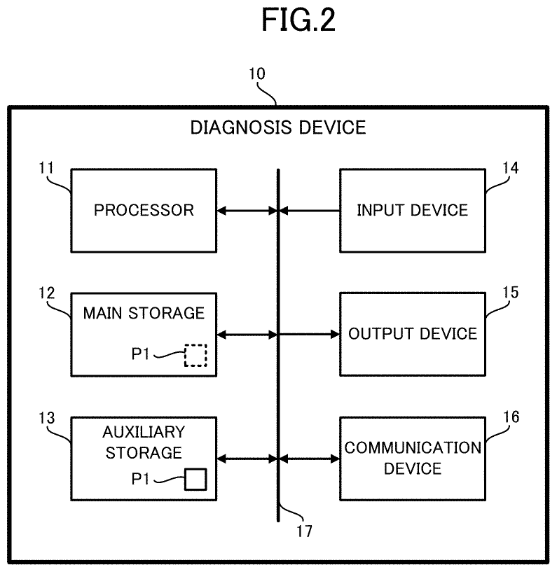

As shown in FIG. 2, the diagnosis device 10 includes, as the hardware components, a processor 11, a main storage 12, an auxiliary storage 13, an input device 14, an output device 15, and a communication device 16. The main storage 12, the auxiliary storage 13, the input device 14, the output device 15, and the communication device 16 are connected to the processor 11 with an internal bus 17.

The processor 11 includes a central processing unit (CPU). The processor 11 executes a program P1 stored in the auxiliary storage 13 to perform various functions of the diagnosis device 10 and performs processes described later.

The main storage 12 includes a random-access memory (RAM). The program P1 is loaded on the main storage 12 from the auxiliary storage 13. The main storage 12 is used as a work area for the processor 11.

The auxiliary storage 13 includes a nonvolatile memory such as an electrically erasable programmable read-only memory (EEPROM) and a hard disk drive (HDD). In addition to the program P1, the auxiliary storage 13 stores various types of data used for performing processes of the processor 11. In accordance with an instruction from the processor 11, the auxiliary storage 13 provides data to be used by the processor 11 to the processor 11 and stores data provided from the processor 11.

The input device 14 includes an input device such as an input key and a pointing device. The input device 14 acquires information input by a user of the diagnosis device 10 and informs the acquired information to the processor 11.

The output device 15 includes an output device such as a liquid crystal display (LCD) and a speaker. The output device 15 provides various items of information to a user in accordance with an instruction from the processor 11. The output device 15 serves as a graphical user interface (GUI) together with the input device 14.

The communication device 16 includes a network interface circuit for communicating with external devices. The communication device 16 receives a signal from an external device and outputs data indicated by the signal to the processor 11. The communication device 16 transmits a signal indicating the data output from the processor 11 to an external device.

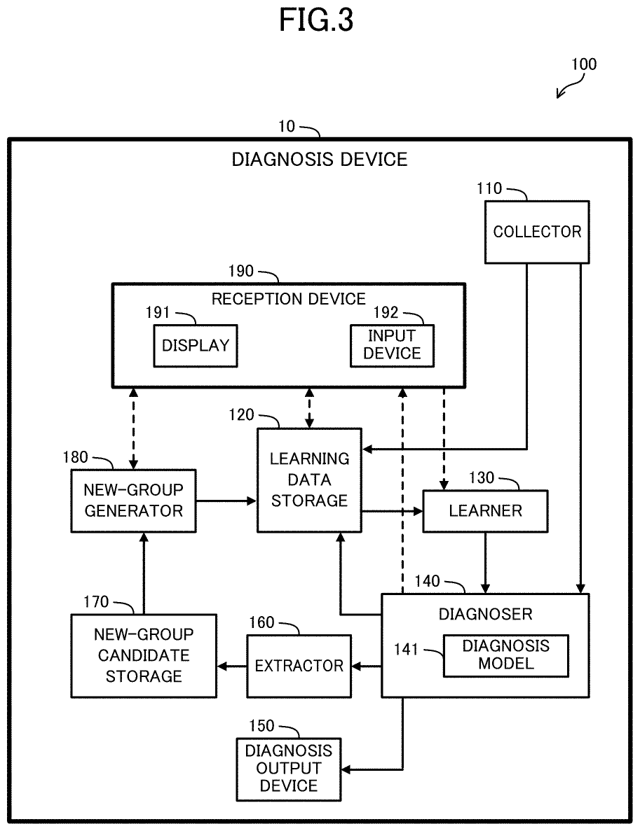

The diagnosis device 10 performs various functions including diagnosis of the operating states of the devices 21 and 22 with the hardware components shown in FIG. 2 operating in cooperation. As shown in FIG. 3, the diagnosis device 10 includes, as the functional components, a collector 110 that collects data pieces from the devices 21 and 22, a learning data storage 120 that stores learning data used by a learner 130 for learning, the learner 130 that learns a diagnosis model 141 for diagnosing presence or absence of an abnormality, a diagnoser 140 that classifies data pieces into multiple groups with the diagnosis model 141 and diagnoses presence or absence of an abnormality, a diagnosis output device 150 that outputs a diagnosis result made by the diagnoser 140, an extractor 160 that extracts a candidate for a data piece to belong to a new group from data pieces collected by the collector 110, a new-group candidate storage 170 that stores the extracted candidate, a new-group generator 180 that generates information indicating the new group from the extracted candidate, and a reception device 190 that receives, from a user, an evaluation of appropriateness of the new group.

The collector 110 is mainly implemented by the processor 11 and the communication device 16 operating in cooperation. At an initial activation of the diagnosis device 10, the collector 110 acquires data transmitted from the devices 21 and 22 and stores the acquired data into the learning data storage 120. The data stored in the learning data storage 120 is used as learning data for generating the diagnosis model 141. After learning of the diagnosis model 141 is complete, the collector 110 sequentially receives data transmitted from the devices 21 and 22 and transmits the received data to the diagnoser 140 as collected data. The collector 110 in the diagnosis system 100 corresponds to an example of collection means for collecting data pieces in a factory.

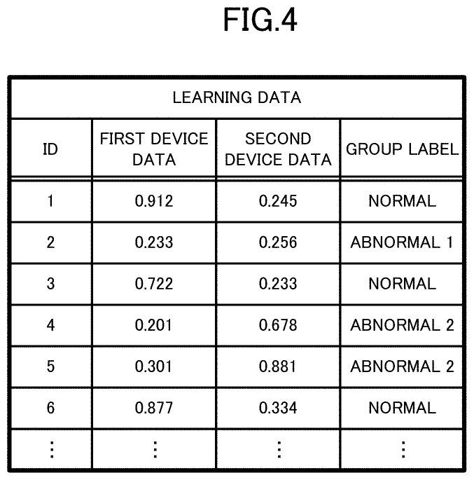

The learning data storage 120 is mainly implemented by at least one of the main storage 12 or the auxiliary storage 13. As illustrated in FIG. 4, the learning data storage 120 stores learning data. The learning data includes an identification (ID) identifying each record, data pieces transmitted from the devices 21 and 22, and a label assigned to a group to which the data pieces belong in association with one another. In FIG. 4, a first device corresponds to the device 21, and a second device corresponds to the device 22. In the example shown in FIG. 4, data pieces each including a combination of a value received from the first device and a value received from the second device are classified into groups each labeled as normal, abnormal 1, or abnormal 2. The first device data piece and the second device data piece are provided from the collector 110, and the labels are assigned by the user through the reception device 190.

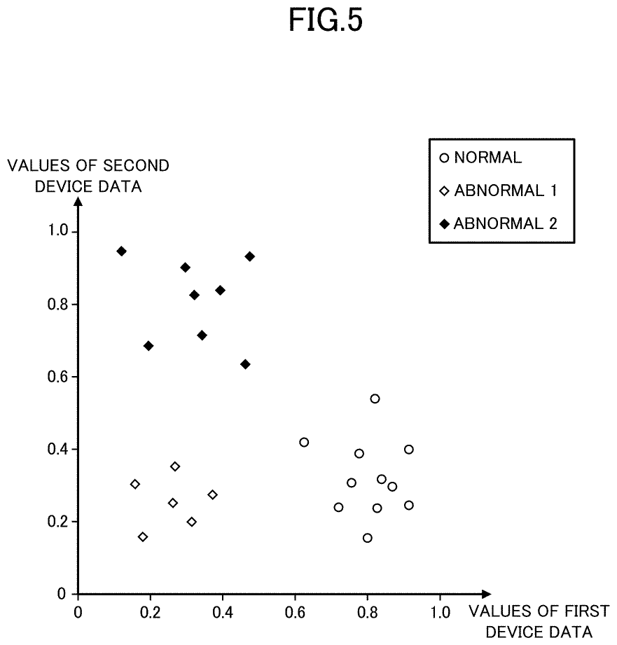

FIG. 5 shows a learning data distribution. As shown in FIG. 5, data pieces with high values of the first device data and low values of the second device data belong to a normal group. Data pieces with low values of the first device data and low values of the second device data belong to an abnormal-1 group. Data pieces with low values of the first device data and high values of the second device data belong to an abnormal-2 group different from the abnormal-1 group. Each group is also called a class.

At the initial activation of the diagnosis device 10, instead of actual values transmitted from the devices 21 and 22, learning data may include values prepared by a user as values possibly transmitted from the devices 21 and 22. The learning data prepared by the user may be received by the reception device 190 from the user and stored into the learning data storage 120.

Referring back to FIG. 3, the learner 130 is mainly implemented by the processor 11. When the reception device 190 receives a learning instruction from the user, the learner 130 reads learning data stored in the learning data storage 120 and learns the diagnosis model 141 for diagnosing a group to which data pieces collected from the devices 21 and 22 belong. The learned diagnosis model 141 is provided to the diagnoser 140 and used for diagnosis performed by the diagnoser 140.

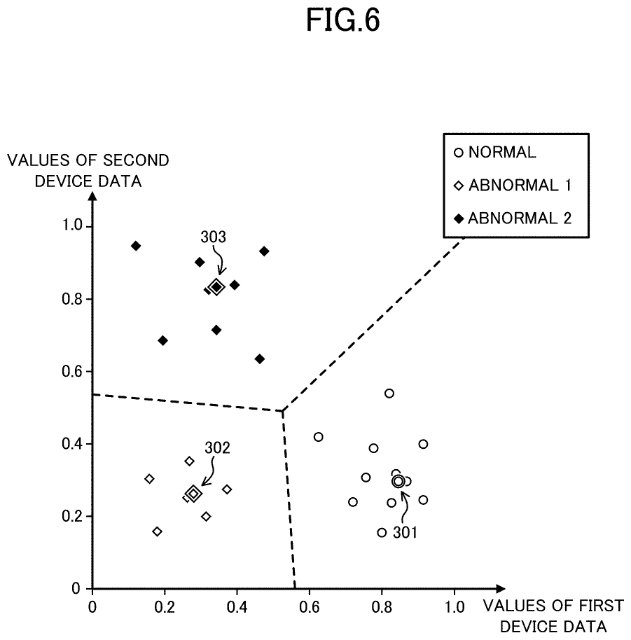

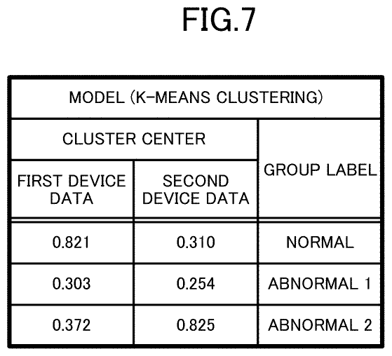

FIG. 6 shows an example of learning the diagnosis model 141 through k-means clustering. FIG. 6 shows a cluster center 301 of the normal group, a cluster center 302 of the abnormal-1 group, and a cluster center 303 of the abnormal-2 group, with cluster boundaries indicated with broken lines. FIG. 7 shows example information indicating a model learned through k-means clustering. As shown in FIG. 7, this model defines the cluster center of each group in association with a label.

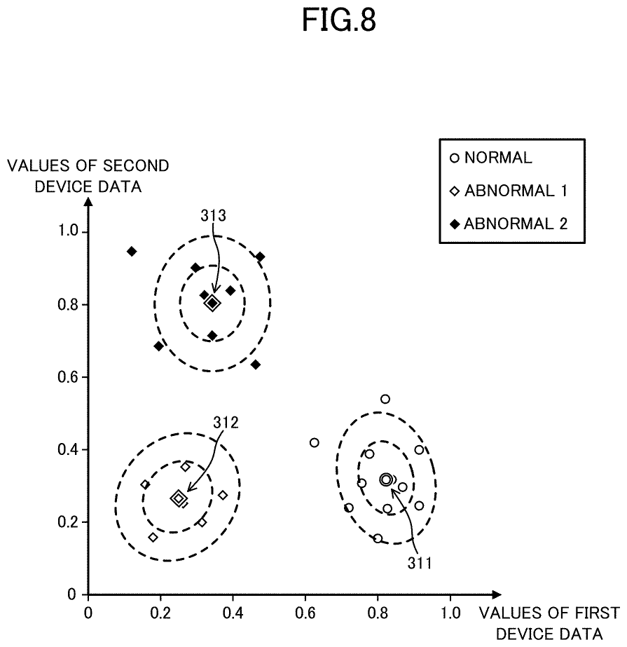

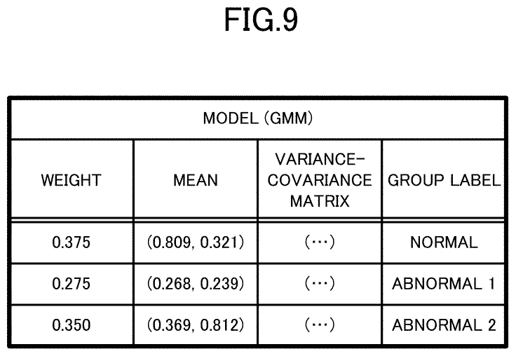

FIG. 8 shows an example of learning the diagnosis model 141 through a Gaussian mixture model (GMM). FIG. 8 shows a Gaussian distribution mean 311 for the normal group, a Gaussian distribution mean 312 for the abnormal-1 group, and a Gaussian distribution mean 313 for the abnormal-2 group, and 1σ and 2σ in each Gaussian distribution are indicated with broken lines. FIG. 9 shows example information indicating a model learned through a GMM. As shown in FIG. 9, this model defines a weight, a mean, and a variance-covariance matrix in a Gaussian distribution for each group in association with a label.

Referring back to FIG. 3, the diagnoser 140 is mainly implemented by the processor 11 and the main storage 12 operating in cooperation. The diagnoser 140 receives the diagnosis model 141 learned by the learner 130 from the learner 130. The diagnoser 140 classifies data pieces collected by the collector 110 from the devices 21 and 22 into any of multiple groups defined by the diagnosis model 141 to determine a label to be assigned to the corresponding data piece and diagnose presence or absence of an abnormality. The diagnoser 140 transmits a diagnosis result including the determined label and each data piece to which the label is assigned to the learning data storage 120, the diagnosis output device 150, and the extractor 160. The diagnoser 140 in the diagnosis system 100 corresponds to an example of diagnosis means for (i) performing a first diagnosis step of diagnosing presence or absence of an abnormality by classifying, in accordance with a model defining a plurality of groups, the collected data pieces into at least one of a plurality of groups, and (ii) performing a second diagnosis step of diagnosing presence or absence of an abnormality with the new model after the learning means learns the new model.

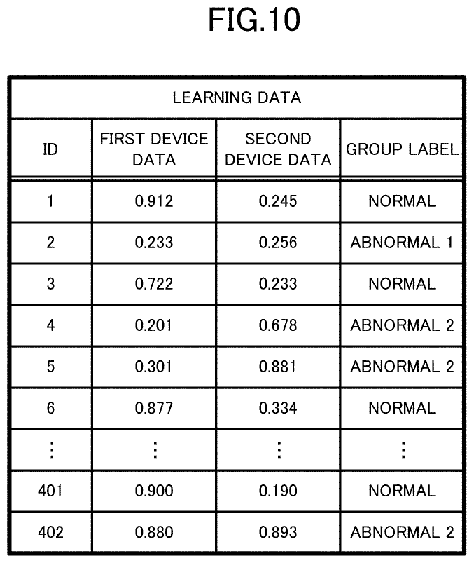

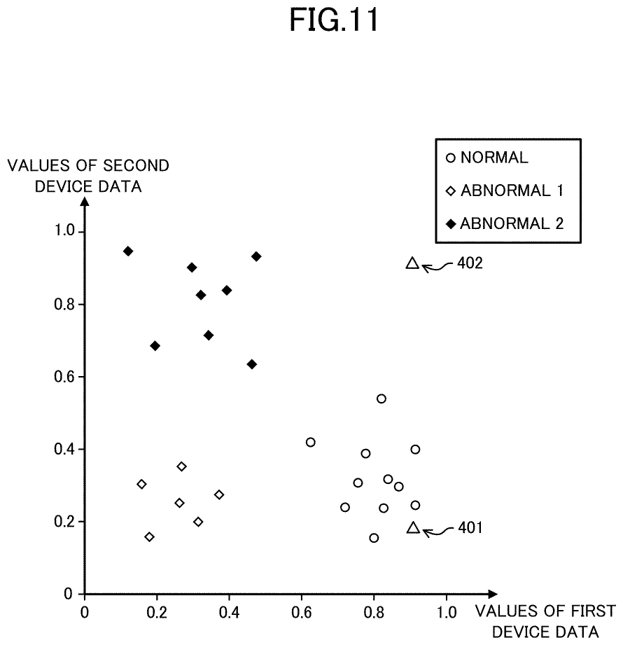

FIG. 10 shows example learning data updated when the diagnoser 140 provides the diagnosis result to the learning data storage 120. In FIG. 10, data including an ID of 401 is determined as belonging to the normal group, and data including an ID of 402 is determined as belonging to the abnormal-2 group. FIG. 11 shows the distribution of data shown in FIG. 10. A point 401 in FIG. 11 corresponds to a data piece including an ID of 401 in FIG. 10, and a point 402 corresponds to a data piece including an ID of 402 in FIG. 10. As shown in FIG. 11, the point 401 is to belong to the normal group, and the point 402 is classified into any one of the normal, abnormal-1, or abnormal-2 group in accordance with the diagnosis model 141, although the group to which the point 402 is to be classified may be unclear.

Referring back to FIG. 3, the diagnosis output device 150 is mainly implemented by the processor 11, the output device 15, and the communication device 16 operating in cooperation. The diagnosis output device 150 outputs a diagnosis result from the diagnoser 140 in real time. Examples of the output from the diagnosis output device 150 include a display on the output device 15, such as an LCD, lighting of a light-emitting diode (LED) indicating an abnormality, an alarm of a buzzer sound, a write into the auxiliary storage 13, and a notice to an external device through the communication device 16.

The extractor 160 extracts a data piece to be possibly classified into an unknown group based on the diagnosis result from the diagnoser 140. More specifically, the extractor 160 calculates the belonging level of each data piece included in the diagnosis result to the group into which the data piece is classified by the diagnoser 140. The belonging level indicates the degree of appropriateness for each data piece to be classified into a certain group. For example, when the diagnosis model 141 is learned through k-means clustering, the belonging level of a data piece decreases as the distance from the cluster center to the data piece increases, and thus the data piece is determined as having a possibility to be classified into an unknown group. When the diagnosis model 141 is learned through a GMM, the likelihood calculated from each Gaussian distribution may be used as the belonging level.

In the example shown in FIG. 11, a data piece corresponding to the point 401 has a high belonging level to the normal group and is thus excluded from extraction targets of the extractor 160, whereas a data piece corresponding to the point 402 has a low belonging level to any group and is thus extracted by the extractor 160. The extractor 160 stores, as the candidate for a data piece to belong to a new group, the extracted data piece into the new-group candidate storage 170 shown in FIG. 3. The extractor 160 in the diagnosis system 100 corresponds to an example of extraction means for performing an extraction step of extracting, from collected data pieces, a candidate for a data piece to belong to a new group different from multiple groups. The belonging level may be determined by the diagnoser 140, and the extractor 160 may select data in accordance with the belonging level.

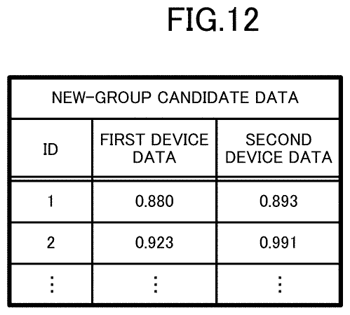

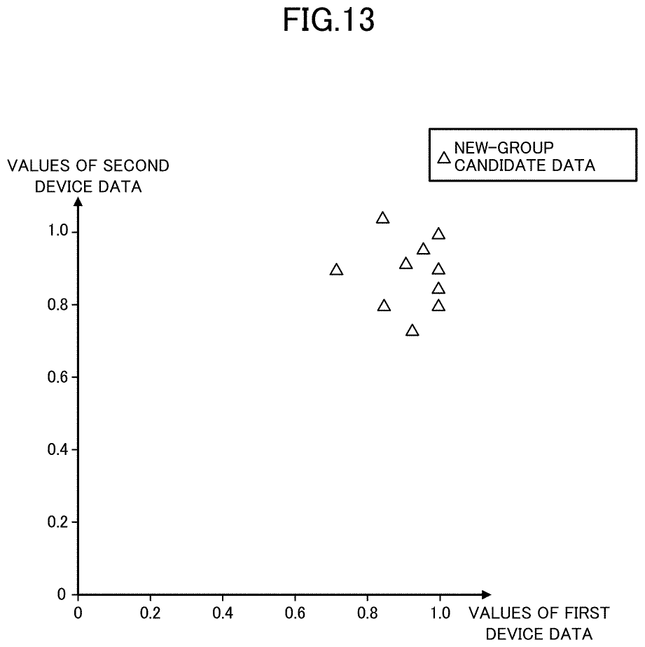

The new-group candidate storage 170 is mainly implemented by at least one of the main storage 12 or the auxiliary storage 13. As illustrated in FIG. 12, the new-group candidate storage 170 stores an ID assigned to each data piece and data pieces collected from the devices 21 and 22 in association with each other. Information stored in the new-group candidate storage 170 is data items as the candidates for a data piece to belong to a new group and thus each of the data pieces is not labeled as any of the normal, abnormal-1, and abnormal-2 groups defined by the diagnosis model 141. FIG. 13 shows a data distribution stored in the new-group candidate storage 170. As shown in FIG. 13, most of the data pieces as the candidates for a data piece to belong to a new group are data pieces that have a higher value for the first device and a higher value for the second device.

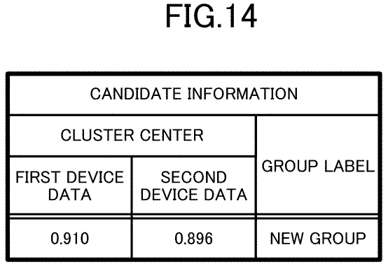

Referring back to FIG. 3, the new-group generator 180 is mainly implemented by the processor 11. The new-group generator 180 reads the data pieces as the candidates stored in the new-group candidate storage 170 and generates candidate information relating to the candidates. The candidate information is information used for defining a new group. FIG. 14 shows example candidate information when the diagnosis model 141 is learned through k-means clustering. The candidate information shown in FIG. 14 defines, as the cluster center of the new group, the centroid of the data pieces as the candidates.

When the amount of data stored in the new-group candidate storage 170 increases to some extent, the new-group generator 180 generates candidate information, whereas when the amount of data is small, the new-group generator 180 waits and avoids generating a new group from mere outliers. Instead of being generated from all the data pieces read from the new-group candidate storage 170, the candidate information may be generated by the new-group generator 180 from some of read data pieces. Instead of information indicating a new group, the candidate information may be the data pieces as the candidates.

The new-group generator 180 transmits the generated candidate information to the reception device 190 shown in FIG. 3. When the reception device 190 receives addition information indicating that a new group is to be added, the new-group generator 180 transmits the candidate information to the learning data storage 120. Data pieces transmitted to the learning data storage 120 are used for learning a new diagnosis model 141 as data pieces that belong to a new group. The new-group generator 180 in the diagnosis system 100 corresponds to an example of generation means for generating candidate information indicating a new group from the candidate extracted by the extraction means.

The reception device 190 is a GUI including a display 191 that displays, to a user, candidate information transmitted from the new-group generator 180, and an input device 192 that receives inputs of the addition information indicating whether a new group is to be added after the user evaluates the appropriateness of the new group based on the candidate information. The display 191 is mainly implemented by the output device 15, and the input device 192 is implemented by the input device 14. The reception device 190 in the diagnosis system 100 corresponds to an example of reception means for performing a receiving step of providing candidate information relating to the candidate extracted by the extraction means and receiving the addition information indicating whether a new group is to be added to multiple groups. The display 191 corresponds to an example of display means for displaying the candidate information, and the input device 192 corresponds to an example of input means for acquiring addition information input by the user.

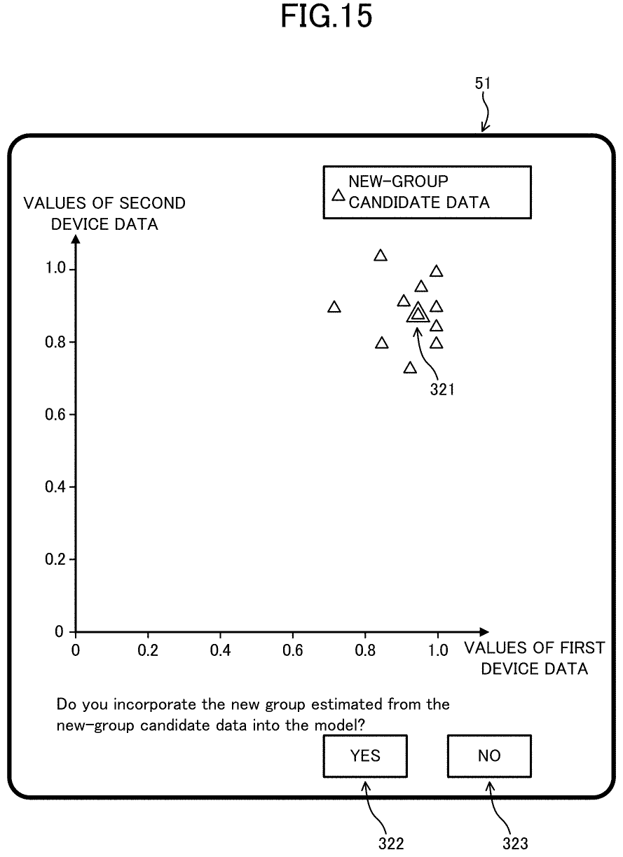

FIG. 15 illustrates a screen 51 appearing on the display 191 in the reception device 190. FIG. 15 shows a distribution of the data pieces as the candidates and a cluster center 321 that defines a new group as candidate information. The user views the screen 51, evaluates the appropriateness of the addition of a new group, and selects a button 322 to input an instruction to add the new group or a button 323 to input an instruction not to add the new group. This selection inputs the addition information to the input device 192 in the reception device 190.

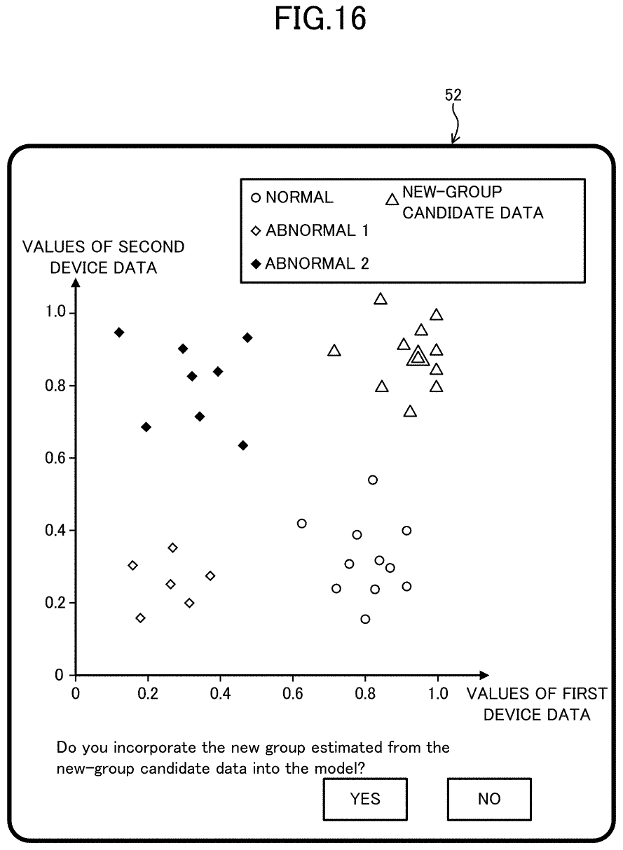

FIG. 16 illustrates a screen 52 displayed for the user as another example. This screen 52 displays data pieces other than those as the candidates for the new group together with a group into which the data is to be classified. The screen 52 is implemented by the reception device 190 reading and plotting diagnosis result data from the learning data storage 120 and overwriting the candidate information.

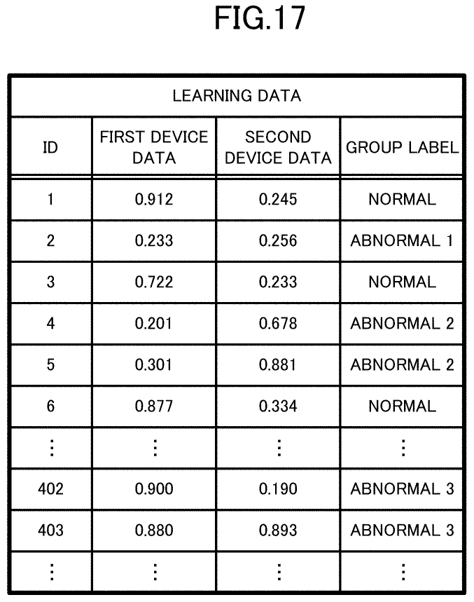

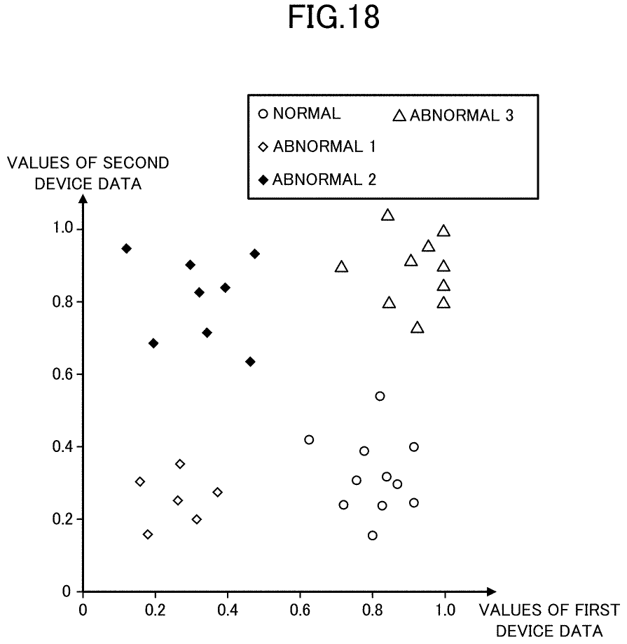

When receiving addition information indicating that a new group is to be added, the reception device 190 causes the new-group generator 180 to store the data pieces as the candidates into the learning data storage 120, receives the title of a new label from the user, and assigns the received new label to the data pieces as the candidates. FIG. 17 shows example learning data including a new label. In FIG. 17, an abnormal-3 label is newly assigned to data pieces with IDs of 402 and 403. FIG. 18 shows the distribution of this learning data. As shown in FIG. 18, data pieces with a higher value for the first device and a higher value for the second device are labeled as abnormal-3.

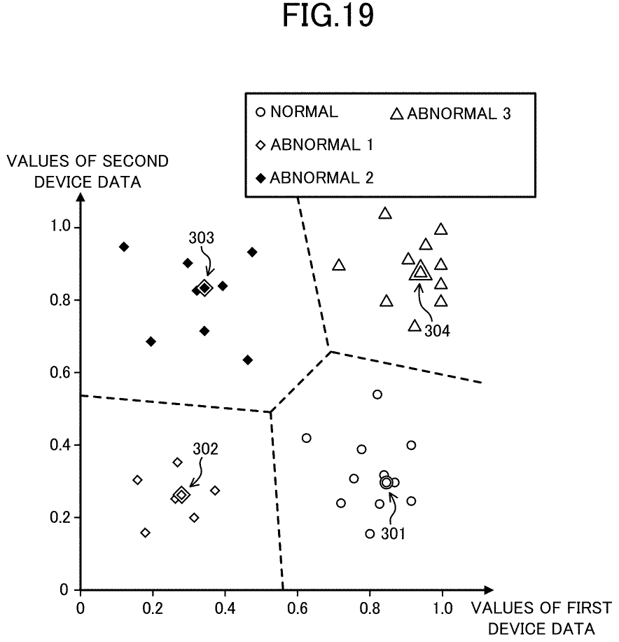

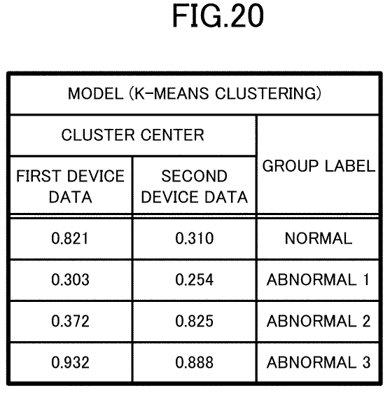

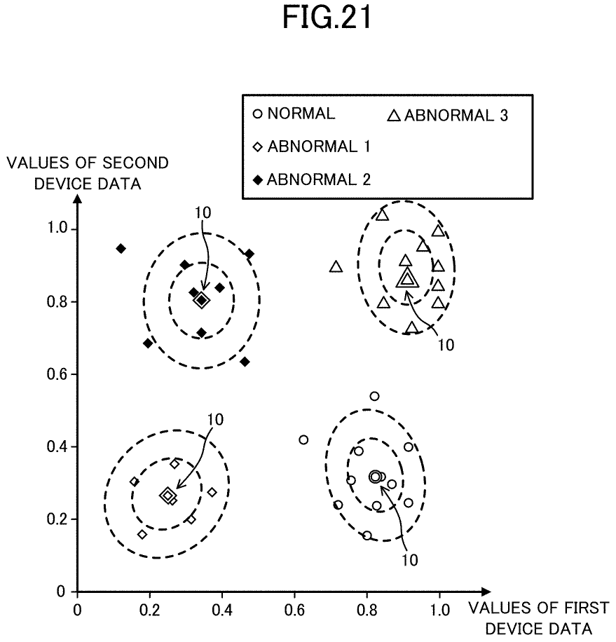

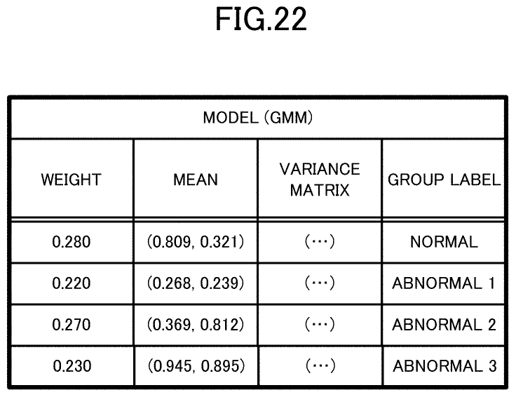

When the reception device 190 further receives an instruction for learning the diagnosis model 141 including a new group from the user, the reception device 190 causes the learner 130 to learn the diagnosis model 141. FIG. 19 shows an example of learning a new diagnosis model 141 through k-means clustering. In the example shown in FIG. 19, a cluster center 304 for a fourth new group is added, and the cluster boundary is updated. FIG. 20 shows information defining a new diagnosis model 141 generated through learning shown in FIG. 19. FIG. 21 shows an example of learning a new diagnosis model 141 through a GMM. In the example shown in FIG. 21, a Gaussian distribution for the fourth new group is added. FIG. 22 shows information defining a new diagnosis model 141 generated through learning shown in FIG. 21. After learning the new diagnosis model 141, the learner 130 provides this model to the diagnoser 140, and the diagnoser 140 updates the diagnosis model 141 used for subsequent diagnoses. For example, the diagnosis model 141 shown in FIGS. 7 and 9 is overwritten with the diagnosis model 141 shown in FIGS. 20 and 22. The diagnoser 140 diagnoses presence or absence of an abnormality with the updated new diagnosis model 141.

The learner 130 in the diagnosis system 100 corresponds to an example of learning means for performing a learning step of learning a new model including a new group when the addition information received by the reception means indicates that the new group is to be added to a plurality of groups.

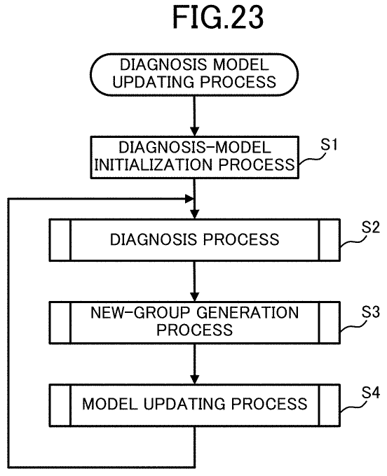

A diagnosis model updating process performed by the diagnosis system 100 is described with reference to FIGS. 23 to 27. The diagnosis model updating process shown in FIG. 23 is started when a power supply for the diagnosis device 10 is turned on. As shown in FIG. 23, the diagnosis model updating process includes a diagnosis-model initialization process (step S1) of initializing the diagnosis model 141, a diagnosis process (step S2) of diagnosing presence or absence of an abnormality based on the diagnosis model 141 from the collected data pieces, a new-group generation process (step S3) of receiving, from a user, a result of evaluation on the candidates for a data piece to belong to a new group, and a model updating process (step S4) of updating the diagnosis model 141.

FIG. 23 shows repetition of steps S2 to S4 in this order after performing step S1. However, steps S2 to S4 may be performed in any order instead of the above order. Steps S2 to S4 may be performed in parallel. Steps S1 to S4 are described sequentially below.

In the diagnosis-model initialization process in step S1, data used for learning of the diagnosis model 141 is stored into the learning data storage 120 from the collector 110 and the reception device 190, and the learner 130 learns the diagnosis model 141.

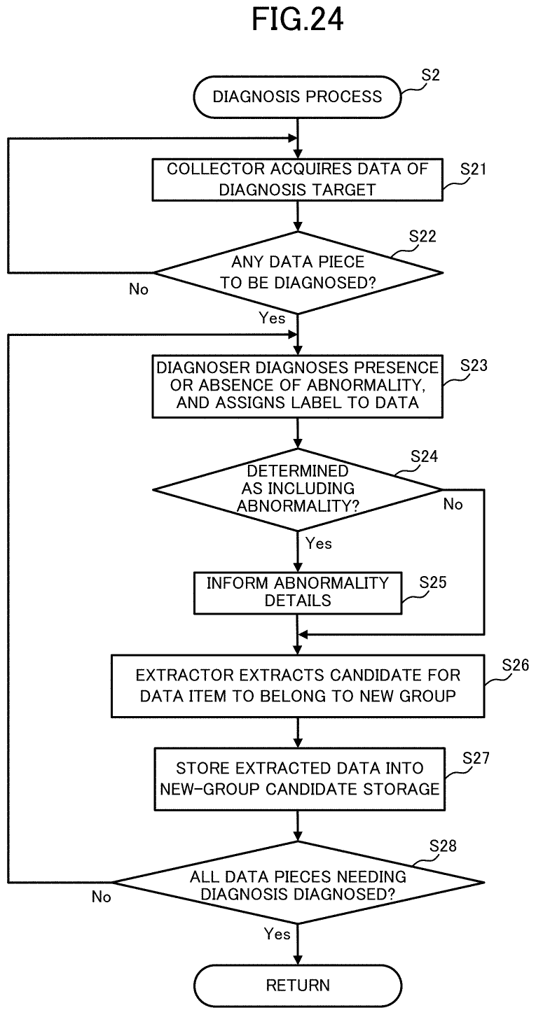

As shown in FIG. 24, in the diagnosis process in step S2, the collector 110 acquires data pieces of a diagnosis target (step S21) and transmits the acquired data pieces to the diagnoser 140. The collector 110 may transmits, together with the acquired data pieces, IDs, time stamps, and other information to the diagnoser 140. When the diagnosis model 141 is used for diagnosing the state from the temporal change in value, as in a waveform acquired from time series data, the collector 110 may transmit, to the diagnoser 140, multiple sampling values after being accumulated.

The diagnoser 140 then determines whether any data piece is left for state diagnosis (step S22). More specifically, the diagnoser 140 determines whether the amount of data pieces transmitted from the collector 110 is sufficient for diagnosis. When the diagnoser 140 determines that no data piece is left for diagnosis (No in step S22), the processing performed by the diagnosis device 10 returns to step S21.

When the diagnoser 140 determines that one or more data pieces are to be diagnosed (Yes in step S22), the diagnoser 140 diagnoses presence or absence of an abnormality in accordance with the diagnosis model 141 and assigns a label to the data piece (step S23). For example, the diagnoser 140 classifies the data piece into any of the normal, abnormal-1, and abnormal-2 groups in accordance with the diagnosis model 141 shown in FIG. 7 and assigns a label for the classified group to the data piece.

The diagnoser 140 then determines whether any data piece has an abnormality (step S24). More specifically, the diagnoser 140 determines whether any data piece is classified into the abnormal-1 or abnormal-2 group. Abnormalities to be determined in step S24 correspond to the presence of a data piece labeled as a predetermined group. When the diagnoser 140 determines that one or more data pieces have an abnormality (Yes in step S24), the diagnoser 140 outputs the diagnosis result to the diagnosis output device 150 to inform the abnormality details to the user (step S25). When informing the abnormality details, the diagnosis output device 150 may also inform the data value, detailed information on the abnormality, and a method for recovering from the abnormality.

After step S25 and when the diagnoser 140 determines that no data piece has an abnormality in step S24 (No in step S24), the extractor 160 extracts the candidates for a data piece to belong to a new group (step S26). The extractor 160 then stores the candidates for a data piece to belong to a new group into the new-group candidate storage 170 (step S27). Thus, the data pieces as the candidates are accumulated in the new-group candidate storage 170.

Subsequently, whether the diagnoser 140 has completed diagnosing all the data pieces to be diagnosed is determined (step S28). When the diagnoser 140 has not completed diagnosing all the data pieces (No in step S28), the processing performed by the diagnosis device 10 returns to step S23. When the diagnoser 140 has diagnosed all the data pieces (Yes in step S28), the processing performed by the diagnosis device 10 returns from the diagnosis process to a diagnosis model updating process shown in FIG. 23.

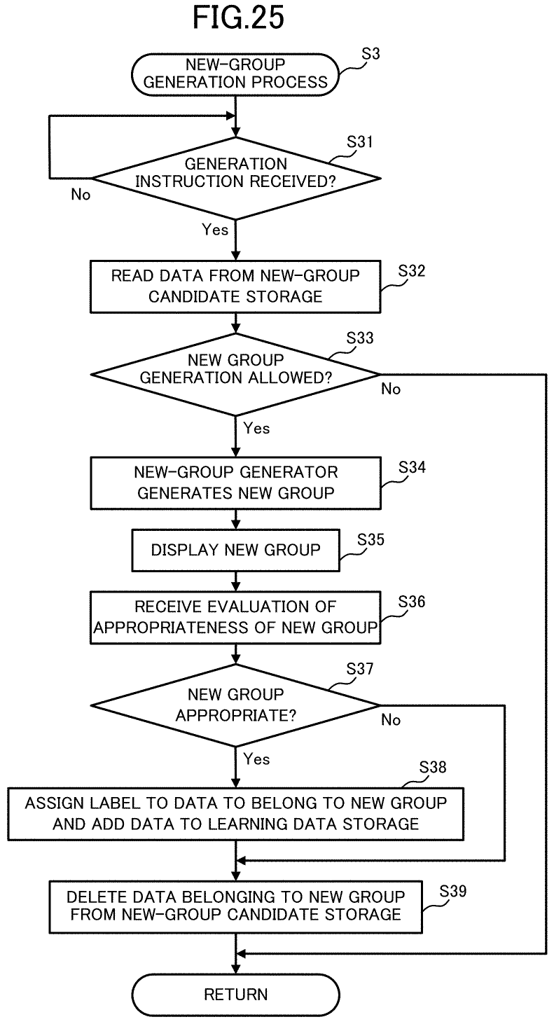

A new-group generation process in step S3 is described. In the new-group generation process, as shown in FIG. 25, the determination is performed as to whether the reception device 190 has received, from the user, a generation instruction to generate a new group (step S31). When the reception device 190 has not received the generation instruction (No in step S31), the reception device 190 repeats the determination in step S31 and waits until receiving a generation instruction.

When the reception device 190 has received the generation instruction (Yes in step S31), the new-group generator 180 reads the data pieces as the candidates from the new-group candidate storage 170 (step S32) and determines whether a new group is to be generated (step S33). A method for generating a new group may be the same as or different from a classification method using the diagnosis model 141. For example, after an attempt to generate a new group through hierarchical clustering such as k-means clustering or Ward's method, the new-group generator 180 determines whether a group satisfying certain conditions has been generated. Examples of certain conditions include elements included in a new group reaching a certain number. Defining such conditions for generating a new group enables distinguishing mere outliers from data pieces belonging to a significant group.

When a new group is not to be generated (No in step S33), the processing performed by the diagnosis device 10 returns from the new-group generation process to the diagnosis model updating process shown in FIG. 23. When a new group is to be generated (Yes in step S33), the new-group generator 180 generates a new group (step S34), and the display 191 in the reception device 190 displays information relating to the new group (step S35). More specifically, the display 191 displays the new group generated by the new-group generator 180 and the data pieces as the candidates for inclusion in the group to prompt a user to evaluate the data piece.

The input device 192 in the reception device 190 then receives a result of evaluation on the new group from the user (step S35). More specifically, the input device 192 receives a result of determination as to whether the new group is to be added to the diagnosis model 141 (step S36). In addition to the determination result, the evaluation of the user may also include information about a group to which the generated new group belongs among the existing groups, whether the new group is different from the existing groups, or whether the group substantially has no value and is thus not to be added. Examples of the group not to be added include a group for mere outliers and a group including intended groups to be distinguished. When a new group is to be added, the reception device 190 receives, from the user, a label title to be assigned to the new group.

The reception device 190 then determines whether a result of evaluation indicating that the new group is appropriate has been received (step S37). When no result of evaluation indicating that the new group is appropriate has been received (No in step S37), the diagnosis device 10 advances the processing to step S39. When a result of evaluation indicating that the new group is appropriate has been received from a user (Yes in step S37), the reception device 190 assigns a label to the data piece to belong to the new group and adds the data piece to the learning data storage 120 (step S38).

The diagnosis device 10 then deletes the data piece belonging to the generated new group from the new-group candidate storage 170 (step S39). This avoids regeneration of the same group. The processing performed by the diagnosis device 10 then returns from the new-group generation process to the diagnosis model updating process shown in FIG. 23.

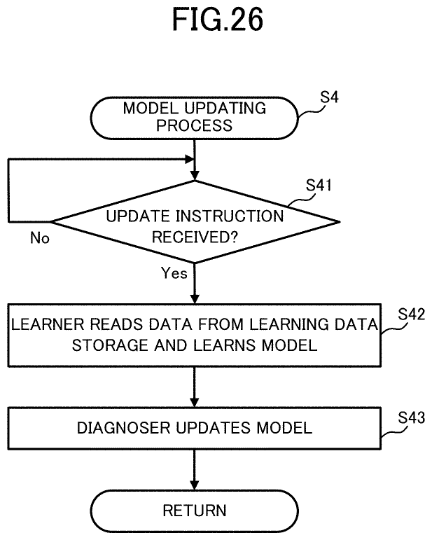

A model updating process in step S4 is described. In the model updating process, as shown in FIG. 26, the reception device 190 determines whether an update instruction for updating the model has been received from a user (step S41). The update instruction may include a method for generating the diagnosis model 141, a parameter used with the method, and other information used to generate the diagnosis model 141. When the update instruction has not been received (No in step S41), the reception device 190 repeats the determination in step S41 and waits until receiving an update instruction.

When the update instruction has been received (Yes in step S41), the learner 130 reads data from the learning data storage 120 to learn the diagnosis model 141 (step S42). In this case, the learner 130 does not use all the data pieces stored in the learning data storage 120 for learning. For example, the data pieces used for learning may be limited to 100 pieces in order from the newest in each group. Information used for learning may be selected. For example, data pieces of at least one of multiple devices may be used for learning. In some embodiments, the update instruction from the user may include settings on data selection.

The diagnoser 140 then updates the diagnosis model 141 to a new diagnosis model 141 learned in step S42 (step S43). The processing performed by the diagnosis device 10 then returns from the model updating process to the diagnosis model updating process shown in FIG. 23.

In the diagnosis system 100 according to the present embodiment, as described above, when the extractor 160 extracts a candidate for a data piece to belong to a new group from the data pieces collected from the devices 21 and 22, and the reception device 190 receives information indicating that the new group is to be added to multiple groups, the learner 130 learns a new model. Thus, the diagnosis system 100 can learn a new model simply when addition of the new group is appropriate, and thus can diagnose presence or absence of an abnormality with the new model. The diagnosis system 100 can thus improve the accuracy of diagnosing presence or absence of an abnormality.

The diagnosis system 100 separately performs the diagnosis process and the new-group generation process. Thus, while diagnosing presence or absence of an abnormality using a diagnosis model corresponding to the data characteristics, the diagnosis system 100 can generate a new group with various methods without being affected by the diagnosis model.

### Embodiment 2

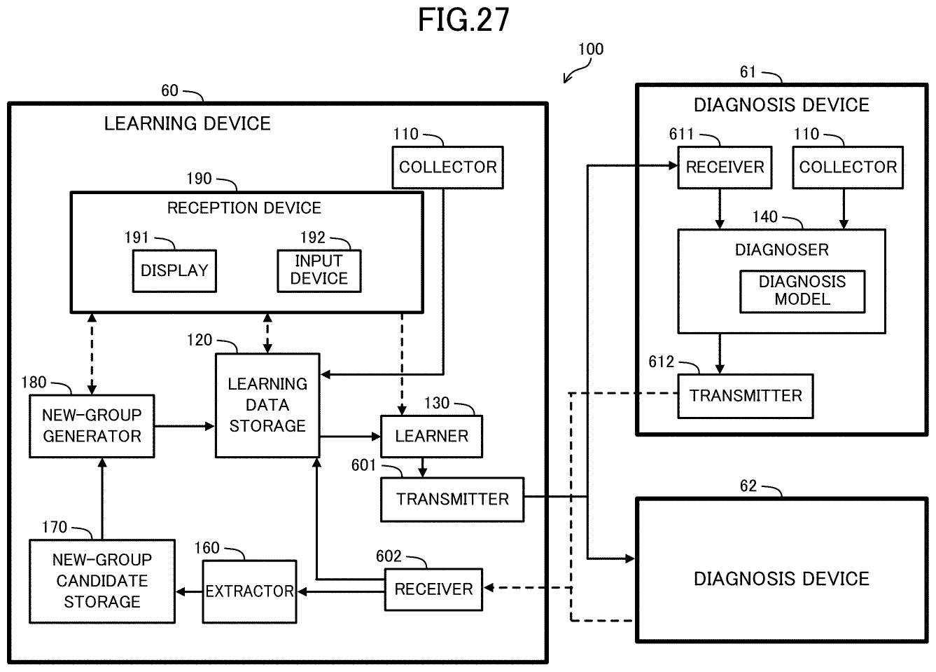

Embodiment 2 is described focusing on the differences from Embodiment 1. The components that are the same as or similar to those in Embodiment 1 are assigned the same reference sign and are not described or are described briefly. As shown in FIG. 27, the present embodiment differs from Embodiment 1 in that a diagnosis system 100 includes a learning device 60 that learns the diagnosis model 141 and multiple diagnosis devices 61 and 62 that diagnose presence or absence of an abnormality with the diagnosis model 141.

Similarly to the diagnosis device 10 in Embodiment 1, the learning device 60 includes a collector 110, a learning data storage 120, a learner 130, an extractor 160, a new-group candidate storage 170, a new-group generator 180, and a reception device 190. The learning device 60 also includes a transmitter 601 that transmits the learned diagnosis model 141 to the diagnosis devices 61 and 62, and a receiver 602 that receives diagnosis results from the diagnosis devices 61 and 62. The transmitter 601 in the diagnosis system 100 corresponds to an example of transmission means for transmitting the new model learned by the learning means to a plurality of diagnosis devices. The extractor 160 acquires the data pieces collected by the diagnosis devices 61 and 62 through the receiver 602 and extracts a candidate to belong to the new group from the acquired collected data pieces.

Each of the diagnosis devices 61 and 62 includes a collector 110, a diagnoser 140, a receiver 611 that receives the diagnosis model 141 transmitted from the learning device 60, and a transmitter 612 that transmits a diagnosis result from the diagnoser 140 to the learning device 60. When the transmitter 601 in the learning device 60 transmits the new diagnosis model 141, the diagnoser 140 diagnoses presence or absence of an abnormality with the new diagnosis model 141.

As described above, multiple diagnosis devices 61 and 62 each including the diagnoser 140 are used for the single learning device 60 including the learner 130 in the present embodiment. Thus, the diagnosis system 100 can collect more data pieces of diagnosis targets and distribute the diagnosis models 141 at once, and thus facilitate management of the diagnosis models 141. The diagnosis system 100 can also transmit the diagnosis model 141 after adjusting the diagnosis model 141 for each of the diagnosis devices 61 and 62.

Although embodiments of the present disclosure have been described above, the present disclosure is not limited to the above embodiments.

In the above embodiments, for example, the learning data storage 120 and the new-group candidate storage 170 are separate components. In some embodiments, a single storage device may include a storage area corresponding to the learning data storage 120 and a storage area corresponding to the new-group candidate storage 170.

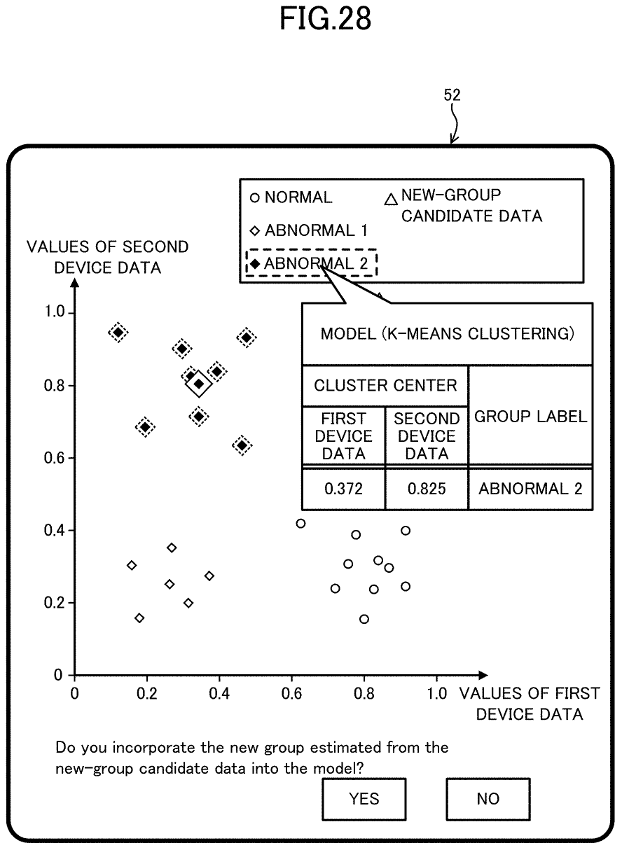

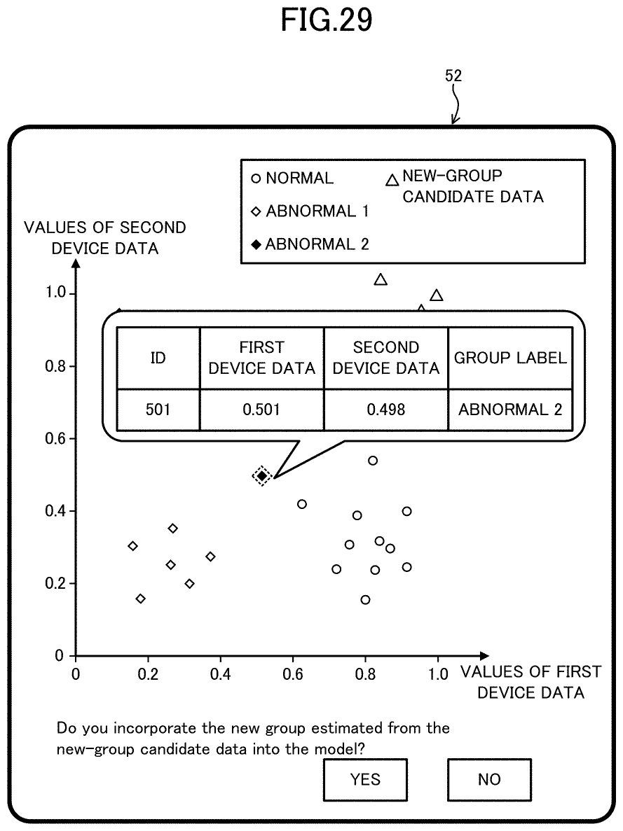

Data pieces determined as belonging to an existing group by the extractor 160 and excluded from extraction of candidates to belong to a new group may be stored into the learning data storage 120 and appear on the display 191. When the user finds an error in a diagnosis result after evaluating the appropriateness of the diagnosis result, the user may operate the input device 192 to correct the diagnosis result. For example, as shown in FIG. 28, the user may change at least one of the coordinates of the cluster center or the group label through a submenu displayed with selection of a label title of abnormal-2. As shown in FIG. 29, the user may input a group change instruction by selecting a single data piece and assigning a group label different from the group to which the data piece belongs. The reception device 190 may then receive the change instruction, and the learner 130 may learn the new diagnosis model 141 from the data piece for which the group is changed in accordance with the change instruction. Thus, when the learner 130 generates a new diagnosis model 141, the determination of the user can be reflected on, besides the data piece determined as belonging to an unknown group, a data piece determined as belonging to an existing group. Thus, independently of a change in a diagnosis reference resulting from a temperature change or a change of a device or equipment, an accurate diagnosis can be performed by updating the diagnosis model 141.

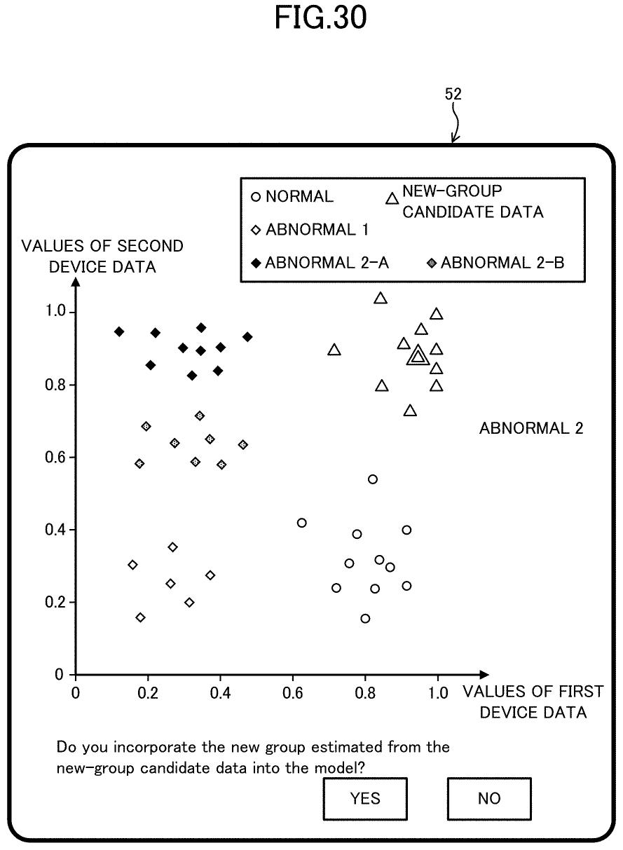

In addition to a data piece determined as belonging to an unknown group, the new-group generator 180 may also classify, into multiple new groups, data pieces stored in the learning data storage 120 and belonging to a single one of the existing groups excluded from extraction performed by the extractor 160. For example, as shown in FIG. 30, the new-group generator 180 may generate an abnormal 2-A subgroup and an abnormal 2-B subgroup from data pieces classified into the abnormal-2 group by the diagnoser 140, and may further classify the data pieces in the abnormal-2 group into these subgroups. When the reception device 190 receives an instruction to update the diagnosis model 141 from the user, the learner 130 may learn the new diagnosis model 141 including the subgroups. Thus, when, for example, a single large group has subgroups, data belonging to the subgroups can be detected.

Instead of those described in the above embodiment, information stored in the learning data storage 120 and the new-group candidate storage 170 may be in any form. For example, when the collector 110 collects image data, link data used for referring to the image data may be stored into the learning data storage 120.

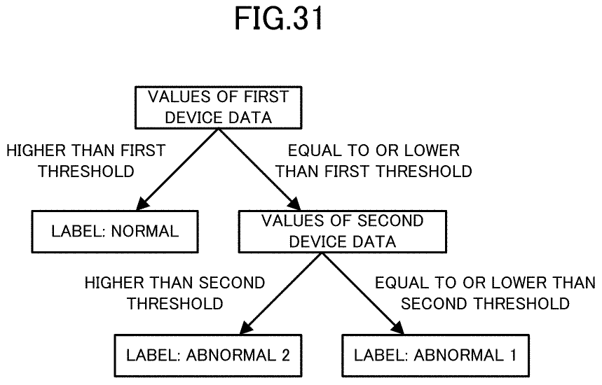

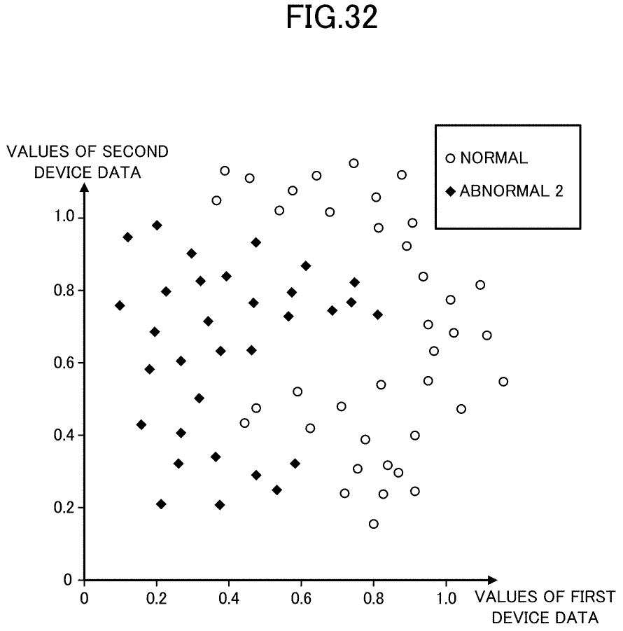

An example method for learning the diagnosis model 141 may be any supervised learning method. For example, a classification method using a decision tree as shown in FIG. 31 can correctly classify complicated distribution data as shown in FIG. 32. In some embodiments, the diagnosis model 141 that outputs diagnosis results may be generated by a combination of multiple methods.

The model updating process may be started at a timing other than the timing of an update instruction from a user. For example, the model updating process may be automatically started immediately after the completion of the new-group generation process or after the elapse of a predetermined time after the update of the previous diagnosis model. Additionally, the display 191 may display information stored in the learning data storage 120 as support information that supports the user to determine the details of the update instruction.

To improve the accuracy of diagnosis in accordance with the diagnosis model 141, the learner 130 and the diagnoser 140 may perform preprocessing on data as appropriate, such as normalization or interpolation of missing values.

The functions of the diagnosis system 100 can be performed by either dedicated hardware or a common computer system.

For example, the program P1 executed by the processor 11 may be stored into a non-transitory computer-readable recording medium for distribution. The program P1 is installed on a computer to provide a device that performs the above processing. Examples of such a non-transitory recording medium include a flexible disk, a compact disc read-only memory (CD-ROM), a digital versatile disc (DVD), and a magneto-optical disk (MO).

In some embodiments, for example, the program P1 may be stored in a disk device included in a server on a communication network, typically the Internet, and may be, for example, superimposed on a carrier wave to be downloaded to a computer.

The above processing may also be performed by the program P1 being activated and executed while being transferred through a communication network.

The above processing may also be performed by the program P1 being entirely or partially executed on a server with a computer transmitting and receiving information on the processes through a communication network.

In the system with the above functions implementable partly by the operating system (OS) or through cooperation between the OS and applications, portions executable by applications other than the OS may be stored in a non-transitory recording medium that may be distributed or may be downloaded to the computer.

Means for implementing the functions of the diagnosis system 100 is not limited to software. The functions may be partly or entirely implemented by dedicated hardware including circuits.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is appropriate for detecting abnormality in a factory.

### REFERENCE SIGNS LIST

10 Diagnosis device
11 Processor
12 Main storage
13 Auxiliary storage
14 Input device
15 Output device
16 Communication device
17 Internal bus
20 Industrial network
21, 22 Device
51, 52 Screen
60 Learning device
61 Diagnosis device
62 Diagnosis device
100 Diagnosis system
110 Collector
120 Learning data storage
130 Learner
140 Diagnoser
141 Diagnosis model
150 Diagnosis output device
160 Extractor
170 New-group candidate storage
180 New-group generator
190 Reception device
191 Display
192 Input device
301 to 304, 321 Cluster center
311 to 313 Mean
322, 323 Button
401, 402 Point
601, 612 Transmitter
602, 611 Receiver
P1 Program

1. A diagnosis system for diagnosing presence or absence of an abnormality from data pieces collected in a factory, the diagnosis system comprising:
diagnosing circuitry to diagnose presence or absence of an abnormality by classifying, in accordance with a model defining a plurality of groups, the collected data pieces into at least one of the plurality of groups;
extracting circuitry to extract, from the collected data pieces, a candidate for a data piece to belong to a new group different from the plurality of groups;
generating circuitry to generate candidate information indicating the new group from the candidate extracted by the extracting circuitry;
a receiver to display a screen indicating the candidate information together with the data pieces belonging to the plurality of groups, and receive from a user an input of addition information indicating whether the new group is to be added to the plurality of groups; and
learning circuitry to learn a new model including the new group when the addition information received by the receiver indicates that the new group is to be added to the plurality of groups, wherein
the diagnosing circuitry diagnoses presence or absence of an abnormality with the new model after the learning circuitry learns the new model.

2. (canceled)

3. The diagnosis system according to claim 1, wherein
the generating circuitry generates a plurality of subgroups into which data pieces that are excluded from the extraction performed by the extracting circuitry and belong to one group of the plurality of groups are to be classified, and
the learning circuitry learns the new model including the plurality of subgroups.

4. The diagnosis system according to claim 1, wherein
the receiver receives an instruction to change a group to which data pieces excluded from the extraction performed by the extracting circuitry belong, and
the learning circuitry learns the new model from the data pieces belonging to the group changed in accordance with the instruction.

5. The diagnosis system according to claim 1, further comprising:
a plurality of diagnosis devices to diagnose presence or absence of an abnormality with the model; and
a learning device to learn the model, wherein
each of the plurality of diagnosis devices includes
collecting circuitry to collect the data pieces in the factory, and
the diagnosing circuitry
the learning device includes
the extracting circuitry to extract the candidate from the data pieces collected by the plurality of diagnosis devices,
the receiver,
the learning circuitry, and
transmitting circuitry to transmit the new model learned by the learning circuitry to the plurality of diagnosis devices, and
the diagnosing circuitry in each of the plurality of diagnosis devices diagnoses presence or absence of an abnormality with the new model transmitted by the transmitting circuitry.

6. A diagnosis method for diagnosing presence or absence of an abnormality from collected data pieces, the diagnosis method comprising:
diagnosing presence or absence of an abnormality by classifying, in accordance with a model defining a plurality of groups, the collected data pieces into at least one of the plurality of groups;
extracting, from the collected data pieces, a candidate for a data piece to belong to a new group different from the plurality of groups;
generating candidate information indicating the new group from the extracted candidate;
displaying a screen indicating the candidate information together with the data pieces belonging to the plurality of groups, and receiving from a user an input of addition information indicating whether the new group is to be added to the plurality of groups;
learning a new model including the new group when the received addition information indicates that the new group is to be added to the plurality of groups; and
diagnosing presence or absence of an abnormality with the learned new model.

7. A non-transitory recording medium storing a program for causing a computer for diagnosing presence or absence of an abnormality from collected data pieces to:
diagnose presence or absence of an abnormality by classifying, in accordance with a model defining a plurality of groups, the collected data pieces into at least one of the plurality of groups,
extract, from the collected data pieces, a candidate for a data piece to belong to a new group different from the plurality of groups,
generate candidate information indicating the new group from the extracted candidate,
display a screen indicating the candidate information together with the data pieces belonging to the plurality of groups, and receive from a user an input of addition information indicating whether the new group is to be added to the plurality of groups,
learn a new model including the new group when the received addition information indicates that the new group is to be added to the plurality of groups, and
diagnose presence or absence of an abnormality with the new model after the learning of the new model.

8. The diagnosis system according to claim 3, wherein
the receiver receives an instruction to change a group to which data pieces excluded from the extraction performed by the extracting circuitry belong, and
the learning circuitry learns the new model from the data pieces belonging to the group changed in accordance with the instruction.

9. The diagnosis system according to claim 3, further comprising:
a plurality of diagnosis devices to diagnose presence or absence of an abnormality with the model; and
a learning device to learn the model, wherein
each of the plurality of diagnosis devices includes
collecting circuitry to collect the data pieces in the factory, and
the diagnosing circuitry,
the learning device includes
the extracting circuitry to extract the candidate from the data pieces collected by the plurality of diagnosis devices,
the receiver,
the learning circuitry, and
transmitting circuitry to transmit the new model learned by the learning circuitry to the plurality of diagnosis devices, and
the diagnosing circuitry in each of the plurality of diagnosis devices diagnoses presence or absence of an abnormality with the new model transmitted by the transmitting circuitry.

10. The diagnosis system according to claim 4, further comprising:
a plurality of diagnosis devices to diagnose presence or absence of an abnormality with the model; and
a learning device to learn the model, wherein
each of the plurality of diagnosis devices includes
collecting circuitry to collect the data pieces in the factory, and
the diagnosing circuitry,
the learning device includes
the extracting circuitry to extract the candidate from the data pieces collected by the plurality of diagnosis devices,
the receiver,
the learning circuitry, and
transmitting circuitry to transmit the new model learned by the learning circuitry to the plurality of diagnosis devices, and
the diagnosing circuitry in each of the plurality of diagnosis devices diagnoses presence or absence of an abnormality with the new model transmitted by the transmitting circuitry.

11. The diagnosis system according to claim 8, further comprising:
a plurality of diagnosis devices to diagnose presence or absence of an abnormality with the model; and
a learning device to learn the model, wherein
each of the plurality of diagnosis devices includes
collecting circuitry to collect the data pieces in the factory, and
the diagnosing circuitry,
the learning device includes
the extracting circuitry to extract the candidate from the data pieces collected by the plurality of diagnosis devices,
the receiver,
the learning circuitry, and
transmitting circuitry to transmit the new model learned by the learning circuitry to the plurality of diagnosis devices, and
the diagnosing circuitry in each of the plurality of diagnosis devices diagnoses presence or absence of an abnormality with the new model transmitted by the transmitting circuitry.
